(19) United States
(12) Patent Application Publication
(10) Pub. No.: US 2011/0276811 A1
(43) Pub. Date: Nov. 10, 2011

(54) IMAGING APPARATUS

(75) Inventors: Takenori UEDA, Aichi (JP); Teruaki NABENO, Aichi (JP)

(73) Assignee: Elmo Co., Ltd., Nagoya-shi (JP)

(21) Appl. No.: 13/101,190

(22) Filed: May 5, 2011

(30) Foreign Application Priority Data
May 10, 2010 (JP) 2010-108025

(51) Int. Cl. G06F 1/26

(52) U.S. Cl. 713/300

(57) ABSTRACT

An imaging apparatus includes an imaging section converting an image taken from an object into an original image signal, an apparatus body outputting an image or video signal to an external display and further delivering an image data signal to a terminal device, an external data input/output terminal including a main data input/output terminal for data communication with the terminal device and an secondary data input/output terminal for connection of peripheral device executing data communication with the terminal device, a single main power supply unit supplying power to the imaging section and the apparatus body, one or more power supply units supplying power to the peripheral device from the secondary data input/output terminal, and a power supply control unit executing control for converting voltage and current of an external power supply into voltages and currents suitable for operations of the imaging section, the apparatus body and the peripheral device respectively.

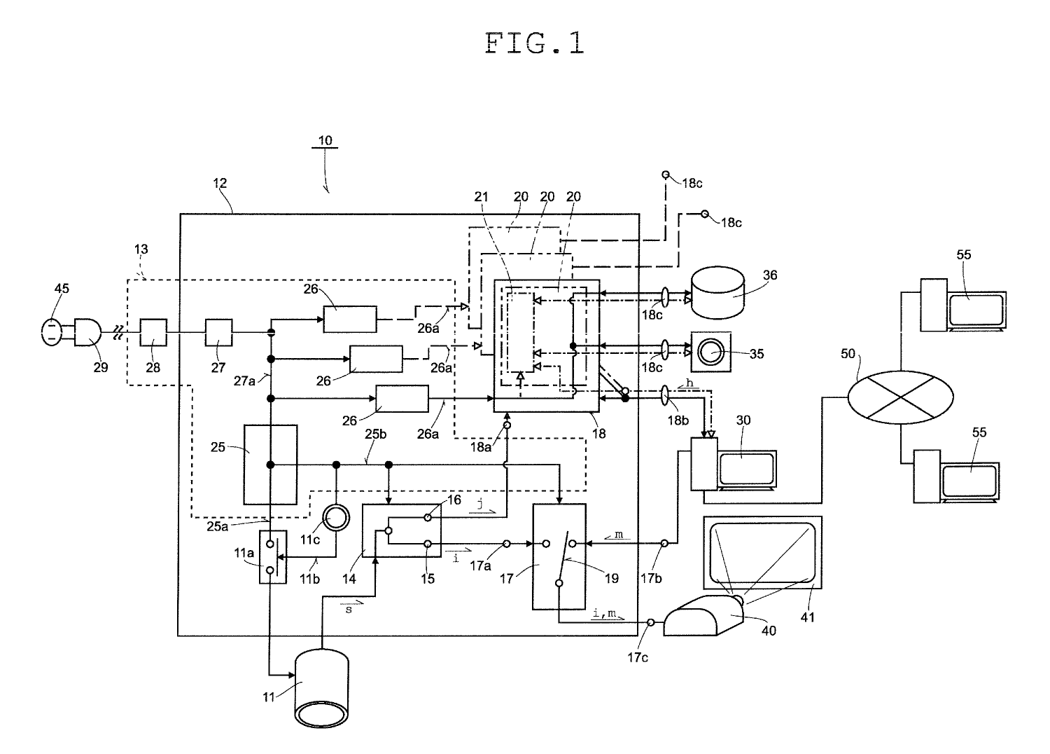

### CROSS-REFERENCE TO RELATED APPLICATIONS

This application is based upon and claims the benefit of priority from the prior Japanese Patent Application No. 2010-108025, filed on May 10, 2010, the entire contents of which are incorporated herein by reference.

### BACKGROUND

1. Technical Field

The present disclosure relates to imaging apparatuses, and more particularly to an imaging apparatus which images an object, electrically converts an obtained image into an original image signal, outputs an image signal based on the original image signal to an external display device such as a projector, while compressing the original image signal into an image data signal to output the obtained image data signal to terminal equipment such as a personal computer.

2. Related Art

Various peripheral devices have recently been available for use with terminal equipment such as personal computers. These peripheral devices include key boards, mouses, image scanners, monitors, printers, hard disc drives and flash memories. The peripheral devices and terminal equipment are connected by data transmission paths conforming to various specifications according to characteristics of the peripheral devices. The specifications for the data transmission paths include universal serial bus (USB).

Devices complying with USB (hereinafter, “USB devices”) are connected to data input/output terminals (hereinafter, “USB ports”) provided in a terminal device, by a USB cable. A conventional terminal device is provided with a plurality of or usually two to four, USB ports. However, the number of USB devices connectable to terminal devices has been increased with widespread use of USB, whereupon the terminal device has run short of the USB ports. Accordingly, a device called “USB hub” having a plurality of USB ports is connected to a terminal device so that the number of USB ports is increased in the terminal device and a plurality of USB devices are connected.

Furthermore, USB ports include a bus-powered type having a function of supplying power to a USB device connected thereto and a self-powered type having no power-supplying function. The terminal device is usually provided with a USB port of the bus-powered type. In this case, power that can be supplied per port is limited to voltage of 5 V±5%, consumption current of 500 mA and consumed power of 2.5 W. The aforementioned limited power supply is further divided by the number of ports of the USB hub in the bus-powered USB hub connected to a USB port of the terminal device. Accordingly, web cameras, card readers, USB memories and the like each of which has small power consumption are mainly connected to the bus-powered USB hub. On the other hand, since the bus-powered USB hub does not necessitate a power supply cable for the USB device to which the USB hub is to be connected, the wiring between the terminal device and the USB device can be simplified.

Furthermore, a USB device incorporated with a bus-powered USB hub has been known. Such a USB device with the USB hub includes a keyboard and a mouse each of which has one to three USB ports. Since the USB device with the USB hub occupies one of the USB ports, the number of available USB ports is reduced by one. Additionally, since power supplied from a personal computer to the USB hub is partially consumed by the occupied USB port, power to be supplied to the other USB ports is limited more than in the case of a single USB hub.

On the other hand, the USB hub with the self-powered USB port is used for data transmission between a personal computer and the USB device. USB devices connected to the self-powered USB hub include printers and scanners, for example. Power supplies are ensured for individual USE devices although the USB devices necessitate higher power consumption. Thus, the USB device with the self-powered port can be operated without depending upon the power supplied from the personal computer. Japanese Patent Application Publication JP-A-2008-193391 discloses a visual presenter as an example of the aforementioned USB device with the self-powered USB port. The disclosed visual presenter includes various connecting sockets which are provided on a rear of a base thereof for ensuring electrical connection with external equipment.

Image signals and image data signals are outputted from the connecting sockets. The image signals are inputted to a display device such as projectors or monitors, whereas the image data signals are inputted to a terminal device for display of the image on a monitor screen or recorded on an external storage medium such as a hard disc drive. As a result, images based on the image signals can be projected onto a screen or the like by a projector in a presentation, a class or the like, whereas images based on the image data can be displayed on the monitor screen of the terminal device located near the visual presenter.

There is an occasion where an image to be displayed is arbitrarily switched between images whose data is stored on an external storage device connected to a terminal device and images obtained by the aforesaid visual presenter in a presentation or a class. In this case, the terminal device and the visual presenter are connected to a display device such as a projector. A data transmission cable and a power supply cable are necessary for connection between the terminal device and the display device. Another data transmission cable and another power supply cable are also necessary for connection between the visual presenter and the display device. This results in an increase in the number of cables and complicates wiring.

There is another occasion where a speaker or a presenter connects an external storage device such as a USB memory or an external hard disc drive to a USB port provided in a terminal device, reading a desired file from the external storage medium to display data stored in the file. Furthermore, when the speaker brings in a terminal device such as his/her own notebook personal computer, the terminal device needs to be connected to a display device, whereupon a connecting work is troublesome. In this case, the display device or the projector is often located away from a location where the speaker takes the rostrum. As a result, reconnection of cables or the like is troublesome. Additionally, since presentations do not proceed from one to another smoothly, there is a possibility of obstructing the class or the presentation.

### SUMMARY

Therefore, an object of the disclosure is to provide an imaging apparatus which can supply electrical power to a plurality of peripheral devices connected to the terminal device from external data input/output terminals, thereby improving the usability of the imaging apparatus.

The disclosure provides an imaging apparatus comprising an imaging section electrically converting an image taken from an object into an original image signal; an apparatus body outputting, to an external display device, an image signal based on the original image signal or a video signal supplied from external video equipment, the apparatus body further outputting, to a terminal device such as a personal computer, an image data signal formed by compressing the original image signal; an external data input/output terminal provided on the apparatus body and including a main data input/output terminal provided for data communication with the terminal device and an secondary data input/output terminal provided for connection of the peripheral device which executes data communication with the terminal device; a single main power supply unit which supplies power to the imaging section and the apparatus body; one or a plurality of auxiliary power supply units which supply power to the peripheral device from the secondary data input/output terminal; and a power supply control unit which executes a control for converting voltage and current of an external power supply into voltages and currents suitable for operations of the imaging section, the apparatus body and the peripheral device respectively.

According to the above-described configuration, the main and auxiliary power supply units are provided, and the external data input/output terminal includes the main data input/output terminal provided for data communication with the terminal device and the secondary data input/output terminal provided for connection of a peripheral device which executes data communication with the terminal device. The auxiliary power supply unit is configured to supply power to the peripheral device connected to the secondary data input/output terminal. Accordingly, the imaging apparatus is usable as a bus-powered hub. Consequently, the cables around the imaging apparatus can be organized.

The imaging apparatus is generally located at speaker's hand. In this case, when each of the terminal device, the peripheral device and the like is connected to the imaging apparatus by a single cable, a highly convenient presentation system centered around the imaging apparatus can be configured.

In an embodiment, the main power supply unit includes a switch for turning on or off the power supply to the imaging section, and the auxiliary power supply unit is configured to supply power of a substantially constant value from the secondary data input/output terminal. As the result of the above-described configuration, a stable power can be supplied to the peripheral device from the secondary data input/output terminal. Consequently, since the peripheral device is operated stably, the reliability and convenience of the imaging apparatus can be improved.

In another embodiment, the auxiliary power supply unit includes a detection unit which detects connection of the terminal device to the main data input/output terminal and further detects connection of the peripheral device to the secondary data input/output terminal. Furthermore, the secondary data input/output terminal is configured to supply power when the peripheral device has been connected to the secondary data input/output terminal under a condition where the terminal device is connected to the main data input/output terminal. As the result of the above-described configuration, excessive power consumption can be suppressed since power to be supplied into an unused terminal is cut off and power is quickly supplied to a terminal to which peripheral device is connected. Consequently, power consumption of the imaging apparatus can be suppressed and the usability of the imaging device can be improved.

In further another embodiment, the auxiliary power supply unit has a secondary data input/output terminal unit comprising one or a plurality of the secondary data input/output terminals bundled. As the result of the above-described configuration, when the number of secondary data input/output terminal units is increased according to the number of peripheral devices, the power supply of the bus power can be prevented from capacity shortage. Consequently, a plurality of peripheral devices can be connected to the imaging apparatus without much regard for power supply capacity one secondary data input/output terminal can supply, whereupon the usability of the imaging apparatus can be improved.

In further another embodiment, the power the auxiliary power supply unit supplies from the secondary data input/output terminal has a voltage lower than the power the main power supply unit supplies. As the result of the above-described configuration, when load is increased in the case where a plurality of peripheral devices is connected to the secondary data input/output terminal, influences with increase in the load can be prevented from spreading to the main power supply unit side. Consequently, the power supplied to the imaging section and the apparatus body by the main power supply unit can be rendered more stable, whereupon the usability of the imaging apparatus can be improved.

In further another embodiment, the external data input/output terminal comprises a USB port. As the result of the above-described configuration, the imaging apparatus serves as a USB hub having a plurality of USB ports. Since USB devices can be connected to the USB ports respectively, various USB devices such as an external hard-disc drive, a USB memory and a web camera can be connected to the USB ports respectively, whereupon the usability of the imaging apparatus can be improved.

### BRIEF DESCRIPTION OF THE DRAWINGS

FIGURE is a schematic block diagram showing the arrangement of the imaging apparatus of an embodiment.

### DETAILED DESCRIPTION

One embodiment will be described with reference to the accompanying drawing. The imaging apparatus 10 includes an imaging section 11, an apparatus body 12 and a power supply 13 supplying electric power to the imaging section 11 and the apparatus body 12. The imaging section 11 includes one or a plurality of lenses (not shown) and an imaging device (not shown) electrically converting an image of an object entered through the lenses. The imaging section 11 outputs an original image signal s obtained by electrically converting the object image. The imaging section 11 further includes a switch 11a, a switching control unit 11b on-off controlling the switch 11a and a power-supply button 11c provided for operating the switching control unit 11b, all of which are provided on the apparatus body 12.

The apparatus body 12 has an image processing section 14 to which the original image signal s is outputted. The image processing section 14 includes an image processing unit which executes an optimization processing such as encoding or decoding with respect to the original image signal s outputted from the imaging section 11. The image processing unit further executes an image segmentation processing according to a usage of the image. The image processing section 14 further has an image output terminal 15 and an image data output terminal 16. An image signal i generated based on the original image signal s is outputted from the image output terminal 15. On the other hand, an image data signal j generated by compressing the original image signal s is outputted from the image data output terminal 16.

The apparatus body 12 also has an image input/output section 17 and a data input/output section 18. The image input/output section 17 has an image input terminal 17a, an external video input terminal 17b, an image output terminal 17c and a switching unit 19. The image signal i is supplied from the image output terminal 15 to the image input terminal 17a. A video signal m is outputted from external video equipment of a terminal device such as a video reproducer or a personal computer. The video signal m is supplied to the external video input terminal 17b. Either image signal i or video signal m is outputted from the image output terminal 17c. The switching unit 19 is automatically or manually switched to the image signal i or the video signal m. As a result, the image input/output section 17 can deliver either image signal i composing the image of the object imaged by the imaging section 11 or video signal m supplied from the external video equipment, from the image output terminal 17c.

A projector 40 serving as an external display device is connected to the image output terminal 17c as shown in the figure. A screen 41 is disposed so as to be opposed to the projector 40. The projector 40 decodes the image signal i or the video signal m inputted thereto to obtain a decoded image or video, which image or video is displayed on the screen 41. The external video input terminal 17b is an RGB input terminal and the image output terminal 17c is an RGB output terminal in the embodiment. However, the external video input terminal 17b and the image output terminal 17c should not be limited to the RGB input and output terminals respectively. Specifications may be selected which are most suitable for a case where an image or a video is inputted or outputted.

A data input/output section 18 has an image data input terminal 18a to which the image data signal j is inputted from the image data output terminal 16. The data input/output section 18 also has an external data input/output terminal comprising a main data input/output terminal 18b provided for data communication with the terminal device 30 and a secondary data input/output terminal 18c to which peripheral devices 35 and 36 are to be connected. The image data signal j inputted to the image data input terminal 18a is outputted from the main data input/output 18b to the terminal device 30.

The peripheral devices 35 and 36 connected to the secondary data input/output terminal 18c are the web camera 35 and an external hard disc drive 36 in the embodiment. Furthermore, the main data input/output terminal 18b and the secondary data input/output terminal 18c are USB ports executing communication complying with the USB specification. However, the communication manner should not be limited to the aforementioned USB specification. A specification such as IEEE1394 may be employed so that data communication is carried out between the terminal device 30 and the peripheral devices 35 and 36 and power is supplied in accordance with the specification.

The secondary data input/output terminals 18c are arranged in parallel in one to four clusters, thereby constituting a secondary input/output terminal unit 20. An auxiliary power supply unit 26 is configured to supply electrical power to the secondary input/output terminal unit 20, as will be described later. A single secondary input/output terminal unit 20 may be provided as shown by solid line in the figure or one or more single secondary input/output terminal units 20 may be added as shown in dotted line in the figure.

The secondary input/output terminal unit 20 has a detection circuit 21 serving as a detecting unit which detects the terminal device 30 and the peripheral devices 35 and 36 in conjunction with the auxiliary power supply unit 26. The detection circuit 21 detects the connection of the terminal device 30 to the main data input/output terminal 18b and the connection of the peripheral devices 35 and 36 to the respective secondary data input/output terminals 18c. The detection circuit 21 instantaneously detects the connection of the peripheral devices 35 and 36 to the respective secondary data input/output terminals 18c when the peripheral devices 35 and 36 are connected to the respective secondary data input/output terminals 18c in the state that the terminal device 30 is connected to the main data input/output terminal 18b. The auxiliary power supply unit 26 operable in conjunction with the detection circuit 21 quickly supplies power from the secondary data input/output terminals 18c. As a result, a signal for data communication or power can be prevented from being supplied from the terminal device 30 to an unused secondary data input/output terminal 18c, whereupon wasted communication line and wasted power can be cut.

The power supply 13 comprises a single main power supply unit 25, one or a plurality of auxiliary power supply units 26 and a single power supply control unit 27. The main power supply unit 25 supplies power to the imaging section 11, the image processing section 14 and the image input/output section 17. The auxiliary power supply units 26 supply power to the data input/output section 18, the detection circuit 21 and the peripheral devices 35 and 36 via the secondary data input/output terminals 18c of the secondary data input/output terminal unit 20. The power supply control unit 27 executes a control of converting the voltage and current of the external power supply 45 to the voltages and currents suitable for operations of the imaging section 11, and the apparatus body 12 and the peripheral devices 35 and 36 respectively.

The main power supply unit 25 has a 12V power supply 25a supplying power to the imaging section 11 and a 5V power supply 25b supplying power to the image processing section 14 and the image input/output section 17. The 5V power supply 25b is also used to operate the switching control unit 11b which executes a control of turning on and off the switch 11a of the imaging section 11. When the power supply button 11c is turned on, the 5V power is supplied to the switching control unit 11b so that the switch 11a is turned on. When the power supply switch 11c is turned off, the 5V power supplied to the switching control unit 11b is cut off so that the switch 11a is turned off. The 5V power supply 25b supplied to the image input/output section 17 is also used for the control of operating the switching unit 19. The switching unit 19 is connected to the image input terminal 17a side when the image signal i inputted to the image input terminal 17a is detected. The switching unit 19 is connected to the external video input terminal 17b side when the video signal m inputted to the external video input terminal 17b is detected. The switching unit 19 is configured to be automatically switched by the 5V power supply 25b in the embodiment. However, the switching unit 19 may be manually switched with the 5V power supply 25b being interrupted, instead.

The auxiliary power supply unit 26 has a 5V power supply 26a obtained by converting the 12V power supply 25a and supplies power to the data input/output section 18 and the secondary data input/output unit 20. The 5V power supply 26a supplied to the secondary supplies power to the peripheral devices 35 and 36 from the secondary data input/output terminals 18c. The 5V power supply 26a supplied to the secondary data input/output unit 20 is limited to voltage of 5 V±5% , consumption current of 500 mA and power consumption of 2.5 W in the embodiment. The 5V power supply 26a supplied to the data input/output section 18 is used by the detection circuit 21 provided in the secondary data input/output terminal unit 20.

When the number of the secondary data input/output terminal units 20 is increased, the number of the auxiliary power supply units 26 is also increased according to the increased number of the secondary data input/output terminal units 20. As a result, the increased secondary data input/output terminal units 20 can individually use the power supply of voltage of 5 V±5%, consumption current of 500 mA and power consumption of 2.5 W. Furthermore, when the number of secondary data input/output terminals 18b provided in the increased secondary data input/output terminal units 20 is increased according to power consumption of the peripheral devices 35 and 36 to be increased, an optimum power can be supplied to the peripheral device 35 and 36 to be connected. Consequently, a plurality of peripheral devices 35 and 36 can be connected according to a manner of use, whereupon the usability of the imaging apparatus 10 can be improved.

The power supply control unit 27 has an AC adapter 28 and a plug 29. The AC adapter 28 executes a control of converting voltage and current of the external power supply 45 thereby to obtain a 12V power supply 27a. Power is supplied from the 12V power supply 27a to the main power supply unit 25 to serve as a 12V power supply 25a. Power is also supplied from the 12V power supply 27a to the main power supply unit 25 and the auxiliary power supply unit 26 thereby to be converted to the 5V power supplies 25b and 26a.

The external power supply 45 is a domestic 100V AC power supply in the embodiment. However, the external power supply 45 may have various voltage values by changing the AC adapter 28, instead. Thus, the imaging apparatus 10 can be used overseas as well as domestically, whereupon the usability of the imaging apparatus 10 can be improved.

The imaging apparatus 10 configured above will be used in the following manner. The 12V power supply 27a is supplied from the AC adapter 28 to the main and auxiliary power supply units 25 and 26 when the plug 29 has been connected to the external power supply 45. The 12V power supply 27a supplied to the main power supply unit 25 serves as the 12V power supply 25a to be supplied to the imaging section 11 without conversion. The 12V power supply 27a is also converted to the 12V power supply 25b to be supplied to the switch 11a of the imaging section 11, the image processing section and the image output section. Additionally, the 12V power supply 27a supplied to the auxiliary power supply unit 26 is converted to the 5V power supply 26a.

The imaging section 11 completes starting preparation and transitions to the standby state when the 5V power supply 25b has been supplied to the switch 11a and the switching control unit 11b. The 5V power supply 25b is also supplied to the image input/output section 17, and the 5V power supply 26a is also supplied to the auxiliary power supply unit 26. In this case, the switching unit 19 of the image input/output section 17 is set so as to be held at the external video input terminal 17b side. Accordingly, the video signal m can directly be supplied from the image output terminal 17c to the projector 40 when having been supplied to the external video input terminal 17b. Furthermore, the auxiliary power supply unit 26 supplies the 5V power supply 26a to the data input/output section 18 and the secondary data input/output terminal unit 20, thereby supplying power to the web camera 35 and the external hard disc drive 36 connected to the detection circuit 21 and the secondary data input/output terminal 17b respectively.

On the other hand, when the power supply button 11c is turned on, the switching control unit 11b is released from the standby state, so that the imaging section 11 starts imaging. The imaging section 11 outputs the original image signal s to the image processing section 14. In this case, the switching control by the switching unit 19 is rendered effective. As a result, the image signal i or the video signal m can be outputted from the image output terminal 17c. More specifically, the image signal i is generated by the image processing section 15 on the basis of the original image signal s. The video signal m is inputted to the external video input terminal 17b. The image signal i and the video signal m are switched therebetween. Furthermore, the auxiliary power supply unit 26 supplies the 5V power supply 26a to the data input/output section 18 and the secondary data input/output terminal unit 20, thereby supplying power to the web camera 35 and the hard disc drive 36 connected to the detection circuit 20 and the secondary data input/output terminal 18b.

Thus, as described above, the auxiliary power supply unit 26 supplies the 5V power supply 26a to the data input/output section 18 and the secondary data input/output terminal unit 20 regardless of the on-off state of the power supply button 11c or the on-off state of the switch 11a of the imaging section 11, as described above.

When the auxiliary power supply unit 26 supplies the 5V power supply 26a to the data input/output section 18, power is supplied from the data input/output section 18 side to the detection circuit 21, thereby starting the detection circuit 21. The detection circuit 21 starts a processing to detect whether or not the main data input/output terminal 18b is connected to the terminal device 30. More specifically, the terminal device 30 is considered to have been connected to the main data input/output terminal 18b, the moment the terminal device 30 is connected to the main data input/output terminal 18b. Subsequently, the data input/output section 18 and the terminal device 30 start data communication. To the main data input/output terminal 18b is periodically inputted a host signal h that confirms that the connected state of the terminal device 30 is continuing.

The detection circuit 21 is also configured to detect the connection of the peripheral devices 35 and 36 to the secondary data input/output terminals 18c. In order that the peripheral devices 35 and 36 may be detected, the terminal device 30 needs to be connected to the main data input/output terminal 18b. In this case, when the peripheral devices such as the web camera 35 and the external hard disc drive 36 are connected to the respective secondary data input/output terminals 18c, the connection of the peripheral devices is instantaneously detected by the detection circuit 21. The 5V power supply 26a is started to be supplied to the peripheral devices 35 and 36 as quickly as possible.

In the case where the terminal device 30 is not connected to the main data input/output terminal 18b, the 5V power supply 26a is not supplied from the secondary data input/output terminal 18b to the peripheral devices 35 and 36 even when the peripheral devices 35 and 36 are connected to the secondary data input/output terminals 18c. In this case, although the detection circuit 21 detects the peripheral devices 35 and 36 connected to the secondary data input/output terminals 18c, the auxiliary power supply unit 26 interrupts the power supply, being on standby for the connection of the terminal device 30 to the main data input/output terminal 18b. Power is supplied from the 5V power supply 26a to the peripheral devices 35 and 36 promptly when the terminal device 30 is connected to the main data input/output terminal 18b.

Subsequently, the peripheral devices 35 and 36 starts data communication with the terminal device 30 via the data input/output section 18. The auxiliary power supply unit 26 stops the supply of 5V power when power switches of the peripheral devices 35 and 36 are turned off such that response in the data communication is broken up for a predetermined time or when the peripheral devices 35 and 36 are pulled out of the secondary data input/output terminals 18c. As a result, congestion in the communication lines can be eased and electric power can be saved.

Furthermore, the imaging apparatus 10 can present an image of the object in a conference room provided with the terminal device 30 and another terminal device 55 both of which are on a network 50. More specifically, talk is carried out while faces are displayed via the terminal devices 55 and the network 50 as in the case of a videotelephone, using the web camera 35 connected to the secondary data input/output terminal 18c. The power supply button 11c of the imaging apparatus 10 is depressed when needed, so that an image of the object imaged by the imaging section 11 is placed on the network 50. On the other hand, the video of a material stored on the terminal device 30 is placed on the network 50 directly from the terminal device 30, while being delivered as a video signal m from the video output terminal 17c to the projector 40.

According to the above-described imaging apparatus 10, power is supplied from the secondary data input/output terminal 18c to the peripheral devices 35 and 36 even when the imaging section 11 is not in the startup state or is in the standby condition. The image output terminal 17c is also usable even in the aforementioned condition. Accordingly, even when nothing is displayed by the imaging section 11, an image displayed on the monitor screen of the terminal device 30 is displayed by the projector 40, and the peripheral devices 35 and 36 can be used which are connected to the secondary data input/output terminals 18c such as the web camera 35 and the external hard disc drive 36. Consequently, when installed in a classroom, a conference room or the like, the imaging apparatus 10 can be used as a USB hub for connection of the USB equipment and can be connected to the terminal device 30 such as a notebook computer.

Additionally, a plurality of secondary data input/output terminal units 20 or a plurality of USB ports serving as the secondary data input/output terminals 18c can be added in each occasion. Accordingly, the USB ports can be added according to a mode of use of the imaging apparatus 10 so that a desired number of USB devices can be connected to the imaging apparatus 10. Consequently, the usability of the imaging apparatus 10 can be improved.

The foregoing description and drawings are merely illustrative of the present disclosure and are not to be construed in a limiting sense. Various changes and modifications will become apparent to those of ordinary skill in the art. All such changes and modifications are seen to fall within the scope of the appended claims.

What is claimed is:

1. An imaging apparatus comprising:
an imaging section electrically converting an image taken from an object into an original image signal;
an apparatus body outputting, to an external display device, an image signal based on the original image signal or a video signal supplied from external video equipment, the apparatus body further outputting, to a terminal device such as a personal computer, an image data signal formed by compressing the original image signal;
an external data input/output terminal provided on the apparatus body and including a main data input/output terminal provided for data communication with the terminal device and an secondary data input/output terminal provided for connection of the peripheral device which executes data communication with the terminal device;
a single main power supply unit which supplies power to the imaging section and the apparatus body;
one or a plurality of auxiliary power supply units which supply power to the peripheral device from the secondary data input/output terminal; and
a power supply control unit which executes a control for converting voltage and current of an external power supply into voltages and currents suitable for operations of the imaging section, the apparatus body and the peripheral device respectively.

2. The apparatus according to claim 1, wherein the main power supply unit includes a switch for turning on or off a power supply to the imaging section, and the auxiliary power supply unit is configured to supply power of a substantially constant value from the secondary data input/output terminal.

3. The apparatus according to claim 1, wherein:
the auxiliary power supply unit includes a detection unit which detects connection of the terminal device to the main data input/output terminal and further detects connection of the peripheral device to the secondary data input/output terminal; and
the secondary data input/output terminal is configured to supply power when the peripheral device has been connected to the secondary data input/output terminal under a condition where the terminal device is connected to the main data input/output terminal.

4. The apparatus according to claim 1, wherein the auxiliary power supply unit has a secondary data input/output terminal unit comprising one or a plurality of the secondary data input/output terminals which are formed into a cluster.

5. The apparatus according to claim 1, wherein the power the auxiliary power supply unit supplies from the secondary data input/output terminal has a voltage lower than the power the main power supply unit supplies.

6. The apparatus according to claim 1, wherein the external data input/output terminal comprises a USB port.
